(19) United States
(12) Patent Application Publication
(10) Pub. No.: US 2011/0184748 A1
(43) Pub. Date: Jul. 28, 2011

(54) Self-administered patient healthcare management system

(76) Inventors: Michael Fierro, Elkridge, MD (US); David Grinberg, Abington, MD (US); William Gillan, Eldersburg, MD (US); Sean Peay, Ellicott City, MD (US)

(21) Appl. No.: 12/660,781

(22) Filed: Mar. 4, 2010

Related U.S. Application Data
(60) Provisional application No. 61/209,206, filed on Mar. 4, 2009.

(51) Int. Cl. G06Q 50/00

(52) U.S. Cl. 705/2

(57) ABSTRACT

A system to help patients manage their healthcare using a comprehensive package of healthcare reminders administered by remote computing and wireless communications devices. Healthy lifestyle, preventive care, chronic condition maintenance care, medication compliance and custom reminders are set according to a schedule and delivered via email, SMS text message, IVR phone message, live voice phone or other communications methods. Participants respond to reminders with their actual progress toward achieving the goal or with data concerning their condition which is recorded and reported. Tools allow users to schedule healthcare provider appointments and receive related reminders and follow-ups, refill prescriptions and generate a variety of reports to track their own progress and condition and which can be shared with a physician. Participating physicians have direct access to patient records to monitor progress and compliance in real time and to communicate with and manage their patients. Integration of personal health records and electronic medical records systems when available permit detailed analysis to identify potential issues and recommend certain reminders to improve the overall quality and integration of care.

### CROSS-REFERENCE TO RELATED APPLICATION(S)

The present application derives priority from U.S. Provisional Application Ser. No. 61/209,206 filed 4 Mar. 2009.

### BACKGROUND OF THE INVENTION

1. Field of the invention

The present invention relates to a personal healthcare and healthy lifestyle management system. More particularly, the present invention relates to an electronically automated system and method for storing and analyzing individual medical data, conditions and goals and promoting compliance with the steps identified as necessary for achieving the individual's goals and maintaining the individual's health by automated reminders.

2. Description of the Background

The median age of the population of the United States in 1990 was 32.8, and according to estimates, had increased to 35.9 by 2001. The rapid increase in the median age over this time period was the result of the aging the baby-boom generation entering its 40's, 50's or 60's. The trend is projected to continue for at least the first quarter of this century. In 2000, 12.4 percent of the U.S. population was over the age of 65. That figure is expected to rise to 13 percent by 2010 and jump to nearly 20 percent by 2030. Indeed, life expectancy in U.S. for the total population is currently (2007) 78,10 years, up from 70.8 years in 1970 due largely to increased vaccination against disease, control of infectious disease through improved sanitation, clean water sources. and the introduction of antibiotics, improved food safety, a decline in deaths from heart disease and stroke resulting from public health efforts to improve the smoking, diet and exercise habits, and more generally, increased access to ever more advanced healthcare.

American's enjoy access to one of the most advanced and sophisticated healthcare systems of any nation and, as a whole, are an increasingly health conscious group even if their health consciousness does not always lead to successful health improvement. As a result, aging Americans typically find themselves managing their health by maintaining and improving their conditions on many fronts. For example, many people regularly work to increase the frequency or regularity of their exercise routines in order to lose weight and improve cardiovascular and skeleto-muscular conditioning. Others set about campaigns of regular preventive care including immunizations (such as flu shots) and cancer screenings (mammograms) and chronic condition maintenance care such as testing (A1C) and monitoring (eye exams) for diabetes patients. Many find themselves on routine daily medications and endeavor to comply with rigid schedules of multiple pill taking. Coordinating, recalling and complying with ail of these efforts along with regular scheduling of healthcare provider visits and coordinating healthcare records and information between providers takes considerable effort and attention to detail.

However, where individuals do comply with the requirements of all of these efforts, studies have shown beneficial results with respect to chronic illnesses and overall health. Regular management of disease may help to identify complications before they become severe. Similarly, it is clear that a healthy lifestyles in terms of diet, exercise, and other habits play an important role in disease prevention and minimization. In as much as chronic illnesses including obesity account for approximately seventy five percent of the $1.25 trillion total healthcare costs in the United States, there is much to be gained, both personally and publically, from improved adherence to healthy lifestyle routines and medical care and maintenance,

The broad concept of a web-based solution to help patients manage their own healthcare is known, as shown in a few prior art references, For example, United States Patent Application 20060111943 by Wu shows a web-based system for analyzing personal health data. A user enters medical data and the application web site performs health risk assessments and search other databases to provide information relevant to the user's health.

United States Patent Application 20080091463 by Shakamuri shows a method for online health management that periodically measures and tracks certain vital signs and then compares those vital signs to published standards of normality. The vital signs are averaged together and a health score is generated which advises the family and health care providers of risks to the patient's health.

United States Patent Application 20080162352 by Gizewski shows a health maintenance system with a subscriber segment that acquires personal and health data, analyzes the data, identifies specific health abnormalities, prescribes health products, instructs on the use of the prescribed health product, and then monitors performance of the product.

United States Patent Application 20010039503 by Chan et al, shows a system for managing a multi-domain health and wellness program using remote terminals. The system collects personal health information and medical record data and analyzes the information. As a result, customized recommendations are provided and may include computer generated recommendations and input from participating third parties (i.e., doctors, dieticians, pharmacists etc.). The communications may be by faxing/emailing/paging critical data either to a healthcare provider or the user, such as “Reminder: take your diabetes medication now.”

United States Patent Application 20040249672 by Bocionek et al. published Dec. 9, 2004 shows a preventive care health maintenance system that sends reminders to users based on their stored medical records and a repository of health maintenance guidelines and associated time information.

U.S. Pat. No. 6,024,699 to Surwit et al. shows a central data processing system configured to communicate with and receive data from a plurality of respective patient monitoring systems, each of which communicates patient data directly from the patient.

United States Patent Application 20060235280 by Vonk et al. shows an electronic health care management system which collects both subjective and objective information regarding a patient into a clinical patient record, and uses the record to determine evidence-based recommendations.

United States Patent Application 20070072156 by Kaufman et al. shows a lifestyle coach behavior modification system which takes user input to determine a current level of the user's behavior, and then establishes an action goal. An action plan is created to reach the action goal. Behaviors of the user are tracked by receiving input regarding the behaviors and behavior measurements. Results are generated by comparing the behavior measurements against the action goal and the action plan. Information is displayed to assist the user to overcome barriers in order to reach the action goal.

United States Patent Application 20080300918 by Tenenbaum et al. shows a system for enabling a patient to book an appointment via an online service with a particular hospital, the online service providing appointment choices for a number of hospitals, the choices being based on attributes including time, insurance, insurance type, patient concern or geography.

U.S. Pat. No. 5,963,136 to O'Brien issued Oct. 5, 1999 shows an interactive prescription compliance and life safety system that monitors taking of medicines by patient queries. The system includes alarm activation when a deviation from a preprogrammed procedure occurs. The claims require a physical prescription dispenser reader that measures use or non use of the dispenser.

Also available at www.changingshape.com website is a personal coaching site that profiles users based on a questionnaire on variety of health behaviors, helps develop a goal-oriented plan (exercise or the like), tracks and scores compliance over time, and provides electronic feedback.

Despite the foregoing limited-purpose health information services, there currently is no web-based solution offering comprehensive healthcare reminders and tracking tools, allowing selection from a variety of different types of reminders including healthy lifestyle (diet and exercise), preventive care (immunizations and cancer screenings), chronic condition maintenance care (A1C and eye exams for diabetes patients), and medication compliance. It would thus be advantageous to provide a system of automated tools to track the wide variety of steps that must be completed, schedules that must be maintained and routines that must be followed in order to improve one's health and well being. The present invention facilitates the effective and efficient recordation of health data and information regarding an individual and utilized modern communication technologies to promote adherence to the identified steps necessary to maintain or improve the persons condition in accordance with those steps and goals.

### SUMMARY OF THE INVENTION

Accordingly, it is an object of the present invention to provide a software driven communications system that enables individuals to assemble, store and manage information regarding their health and medical condition.

It is another object to provide a system to analyze stored information in order to quantify their current status in relation to future health maintenance and improvement goals.

It is another object to provide a system that enables the individual to identify and/or record the steps and milestones necessary to reach their future health maintenance and improvement goals and that promotes completion of those steps and reaching of milestones by providing positive automated reminders to the user via electronic communications means.

It is another object of the present invention to provide a system that permits users to enable their healthcare providers to monitor in real time their progress toward their goals and/or their adherence to the identified steps necessary to reach those goals and to permit the healthcare provider to provide feedback and advice to the user in real time.

It is yet another object of the present invention to permit employers and insurers to document employee health and wellness measures efforts so as to be able to reduce and control health care insurance premiums.

Yet another object is to provide a system that permits the scheduling and/or provision of healthcare products and services as required to meet the individual future health maintenance and improvement goals and milestones of the user.

Yet another object is to allow lifestyle coaches, personal trainers, and similar individuals to set up and store programs of reminders for their client-users.

Still another object is to allow any user of the system to identify and define a challenge they would like to issue to another user or group of users, such as physical fitness challenges or healthy lifestyle challenges.

According to the present invention, the above-described and other objects are accomplished by a web-based solution to help patients manage their healthcare using a comprehensive package of healthcare reminders and tracking tools. Registered users access a list of reminder types including healthy lifestyle, preventive care, chronic condition maintenance care, medication compliance and custom reminders in order to set up schedules for reminders to be delivered via email, SMS text message, IVR phone message, live voice phone or a combination of these or other communications methods. For self-administered activities such as healthy lifestyle care, participants set up goals and respond regularly with their actual progress such as their frequency and duration of exercise or total caloric intake which is recorded and reported against their identified goals. A similar response mechanism is utilized for necessary health maintenance activities such as self-monitoring of blood pressure or glucose self-testing where test results may be reported to the system for recordation and monitoring.

Other tools allow users to enter healthcare provider appointment information in order to allow the system to send reminder notices to the user prior to the appointment. Integration of healthcare provider schedule availability permits the user the option of scheduling or rescheduling, if necessary, an appointment via the system. For medication reminders the system not only reminds people when it is time to take their medicine and tracks compliance but records the user's supply of their prescriptions and provides reminders for the user to refill prescriptions appropriately. Integration with pharmacies permits automated submission of refill requests in many cases via the system.

Still other tools within the system allow the user to generate a variety of reports that are valuable to track their own progress and condition and which can be shared with a physician to provide a snapshot over a time more accurate than the patient's recollection. Users may grant their participating physicians direct access to their records to monitor progress and compliance in real time to communicate with and manage their patients. Integration of personal health records and electronic medical records systems from participating healthcare providers allows the system to perform detailed analysis and recommend certain services that may be valuable or useful to patients and to share healthcare information between multiple providers to improve the overall quality and integration of care.

Still other tools within the system allow lifestyle coaches, personal trainers, and similar individuals to set up and store programs of reminders for their client-users, and allow any user of the system to identify and define a challenge they would like to issue to another user or group of users, such as physical fitness challenges or healthy lifestyle challenges.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a top level diagram illustrating the software of an embodiment of the present invention.

FIG. 2 is a schematic of the hardware configuration of an embodiment of the present invention

FIG. 3 is an illustration of a web portal home page log in security screen.

FIG. 4 is an illustration of a create new account screen.

FIG. 5 is an illustration of automatic generation of a first participant.

FIG. 6 is an illustration of billing information entry screen.

FIG. 7 is an illustration of an initial participant list.

FIG. 8 is an illustration of create new participant screen.

FIG. 9 is an illustration of a new participant charge confirmation.

FIG. 10 is an illustration of a subsequently populated participant list.

FIG. 11 is an illustration of an initially empty current reminders list.

FIG. 12 is an illustration of a reminder type selection screen.

FIG. 13 is an illustration of service type selection screen.

FIG. 14 is an illustration of a service setup screen for dental exam reminder.

FIG. 15 is an illustration of a scheduling tool for dental exam reminder scheduling.

FIG. 16 is an illustration of a service setup screen for a medication reminder.

FIG. 17 is an illustration of a scheduling tool for medication reminder scheduling.

FIG. 18 is an illustration of prescription refill option selection screen.

FIG. 19 is an illustration of prescription refill detail information screen.

FIG. 20 is an illustration of a populated current reminder list.

FIG. 21 is an illustration of an email reminder.

### DETAILED DESCRIPTION OF THE PREFERRED EMBODIMENTS

A web-based computer and software enabled solution is disclosed to help patients manage their healthcare and wellbeing using a comprehensive package of healthcare reminders and tracking tools, Registered users access a list of reminder types including healthy lifestyle, preventive care, chronic condition maintenance care, medication compliance and custom reminders in order to schedule reminders to be delivered via email, SMS text message, IVR phone message, live voice, or a combination of these or other electronic communications methods, With respect to self-administered activities such as healthy lifestyle care, participants identify goals and respond regularly with their actual progress toward those goals such as their frequency and duration of exercise or total caloric intake which is reported against their target, A similar response mechanism is utilized for necessary health maintenance activities such as self-monitoring of blood pressure or glucose self-testing where test results may be reported to the system for recordation and monitoring.

Other tools allow users to enter healthcare provider appointment information in order to allow the system to send reminder notices to the user prior to the appointment. Integration of healthcare provider schedule availability will permit the user the option of rescheduling an appointment if necessary via the system and, in some cases, originally scheduling their appointments on-line. For medication reminders the system not only reminds people when it is time to take their medicine and tracks compliance but records the user's supply of their medicines and provides reminders for the user to refill their prescriptions appropriately. Integration with pharmacies permits automated submission of refill requests in many cases via the system.

Still other tools within the system allow the user to generate a variety of reports that are valuable in tracking their own progress and condition and which can be shared with a physician to provide a snapshot over a time that is more accurate than the patient's recollection, Users may grant their participating physicians direct access to their records to monitor progress and compliance in real time and to communicate with the patient and manage the patient's efforts. Integration of personal health records and electronic medical records systems maintained by participating healthcare providers allows the system to perform detailed analysis and recommend certain services that may be valuable or useful to patients and to share healthcare information across multiple providers to improve the overall quality and integration of care.

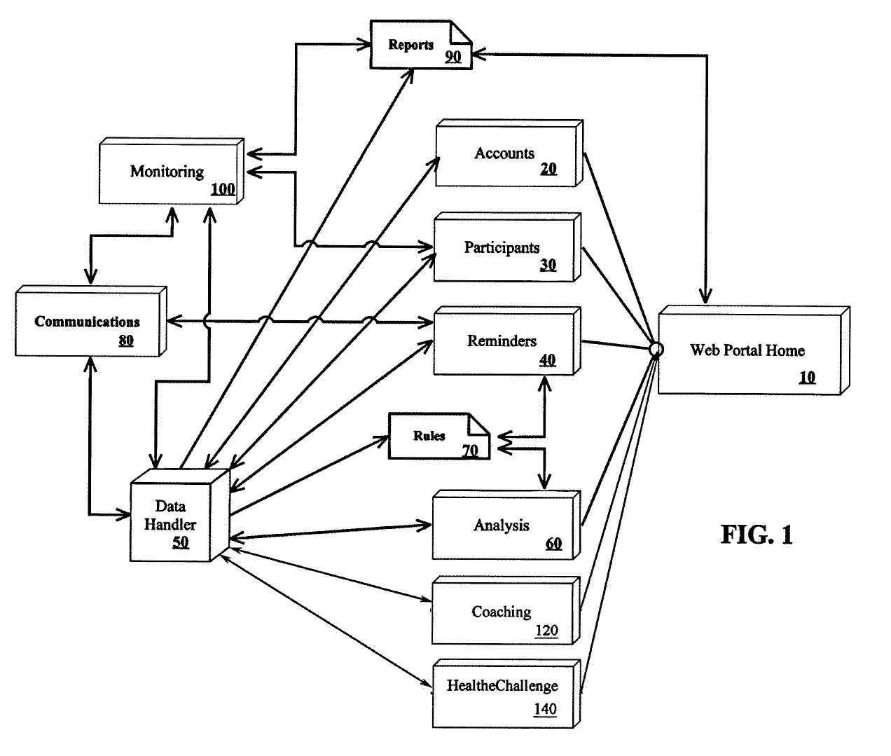

FIG. 1 is a top level diagram illustrating the software of the present invention, which is accessible through a main web portal home page 10. The web portal provides access to the following the following modules:
(1) Account Module 20: manages account maintenance and billing information with respect to individual account holders as distinguished from participants. Account holders for billing purposes may be employers or other group organizers that provide the service of the present system to their members or may be a participating member him/herself.
(2) Participants module 30: manages participant information within an account. An account may have one or more participants associated with it. Participants within the same account may or may not be able to view information pertaining to other participants within the account.
(3) Reminders Module 40: allows for entry or generation of reminders and managing of delivery modes. The Reminders Module interfaces with the Communications module 80 in order to provide participant specified reminder messages. The Reminder Module further interfaces with the Rules Module 70 and the Analysis Module 60 when generating certain automatically created reminders.
(4) Data Module 50: manages storage of participant entered health and other data including, in some, embodiments electronic medical records and data provided by third parties including healthcare providers (physician etc.). The data module also stores rules Data from the Rules Module along with administrative data from other modules such as the Accounts Module 20.
(5) Analysis Module 60: analyses entered and reported health and goal data to identify appropriate steps based on the provided rule set. The Analysis Module also analyzes electronic health records to similarly identify and recommend appropriate steps and goals when such records are available with respect to a participant,
(6) Rules Module 70: provides the healthcare rules and recommendations on which the analysis of the Analysis Module 60 is based. Rules may be standard recommendations as provided by government agencies and other sources or customizable rules as determined by the account holder. The healthcare rules and recommendations are also used by the Reminders Module 40 in conjunction with user created reminder scheduling,
(7) Communications Module 90: performs the interface with reminder delivery systems such as internet and telecommunications systems as well as acting as a communications go-between with respect to the Monitoring Module 100 and participant authorized healthcare providers.
(8) Reporting Module 80: for generating historical and analytical reports for users and authorized healthcare providers.
(9) Monitoring Module 100: For providing access to designated health care providers to participant data for monitor participant activity.
(10) Coaching Module 120: For use by case managers, lifestyle coaches, personal trainers, and similar individuals (all subsequently referred to as coaches) to set up and store programs of reminders for their client-users.
(11) HealtheChallenge module 140. For allowing any user of the system to identify and define a challenge they would like to issue to a group of users. A challenge may include things such as physical fitness challenges (total or average miles am over a certain period of time, weight lifted, etc), healthy lifestyle challenges (weight loss, smoking cessation), etc.

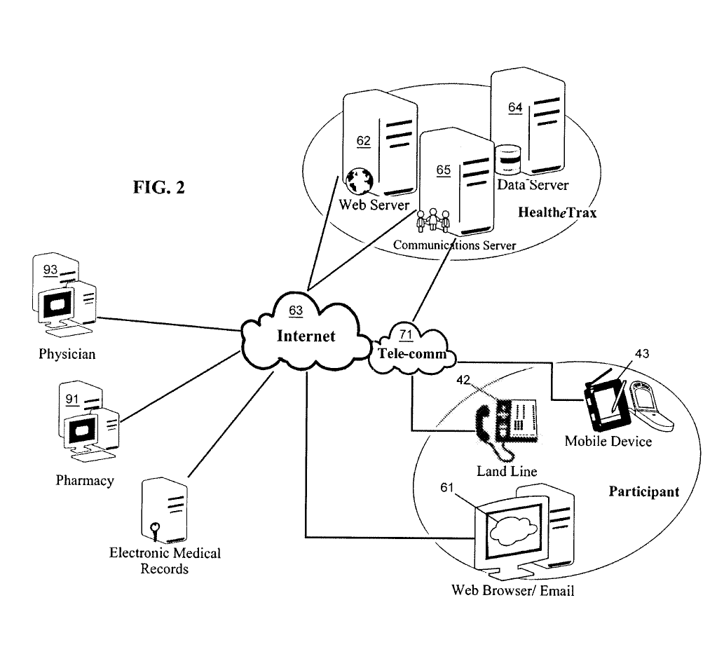

With reference to FIG. 2, initial access to the present invention by the user is preferably obtained via a world wide web portal displayed by a web browser 61 on a computer workstation of the participant. Computer workstations utilizing any of a variety of known operating systems such as Microsoft Windows or other running locally via a microprocessor based central processing unit are preferable. The web browser is similarly stored in and read from memory as is necessary to access the web portal, The web portal is provided by a web enabled server 62 remotely located and connected to the workstation via the Internet 63 or other communication network. Both client workstations and servers are provided with network interface controllers (wired or wireless) operating on the physical layer and the data link layer of the OSI networking model to facilitate communication between the devices via a network. The web-enabled back-end server(s) 63, database server 64, Communications Server 65 and website may be maintained by a third party application service provider. The database server 64 and the web server 63 may be separate servers and are similar to the previously described data server from a physical standpoint, as is the local machine.

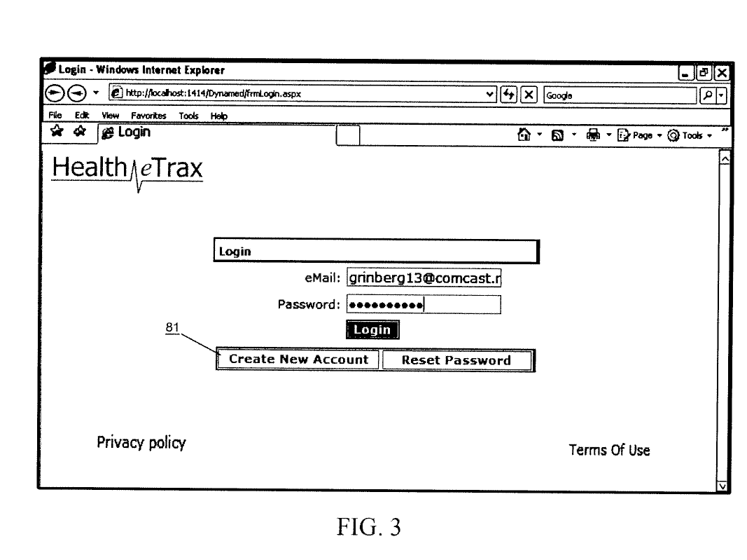

With reference to FIG. 3, access to the web portal may be restricted through the use of user credentials such as a username and password received after proper registration. The user is initially directed to the main web portal's Home page. From the Home page, the user has access to the above-described modules of the present invention on verification of user credentials. FIG. 3 is a screen print of an exemplary login screen of the web portal home page. Individuals reaching this page but not having credentials are invited to create an account by clicking on a “create new account” link 81. Login credential are verified against records maintained by the Account Module 20 in the Data Module 50 and, where an account includes more than one participant, the Participant Module 30. The level of services available and the participant information available varies as a function of the permissions related to a particular individual which are a function of the role of the individual.

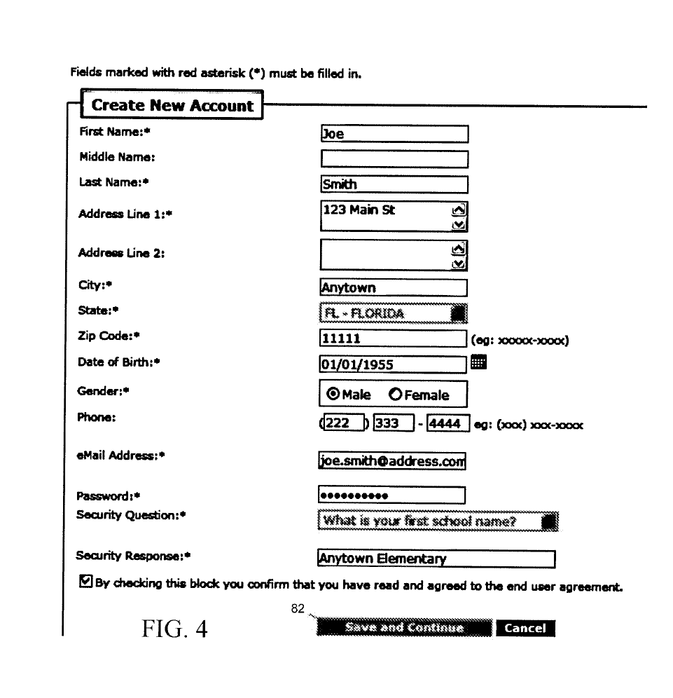

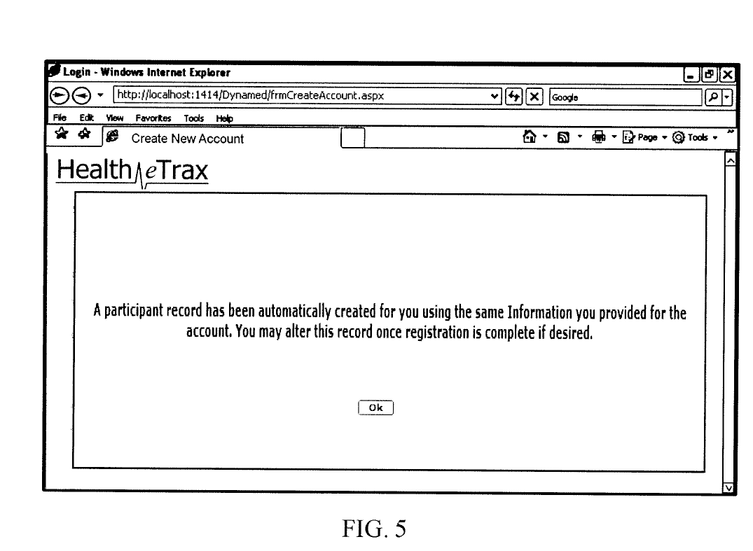

FIG. 4 is a screen print of an exemplary new account screen presented to a user who has clicked on the “create new account” link 81. If the user is an employer sponsored or otherwise sponsored user, the new account screen will be pre-populated with information provided by the sponsor and correlated to the individual based on user provided indentifying information such as, in the exemplary figure an email address. For sponsored implementations of the present invention or for individually sponsored users the trademarks and identifying indicia of the system operator may be replaced by those of the sponsoring entity. Non-sponsored new users will be required to input all necessary information. Once the user has entered or verified the required information the “Save and Continue” button 82 is clicked and the system automatically generates an initial participant record, as indicated in the message of FIG. 5. Participants are distinct from account holders as a single account may have multiple participants such as, for example, when one spouse is a participant on an account sponsored by the employer of the other spouse.

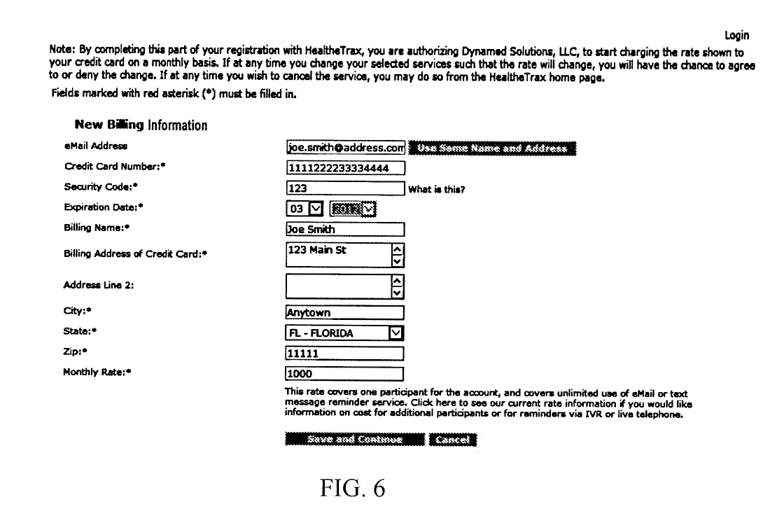

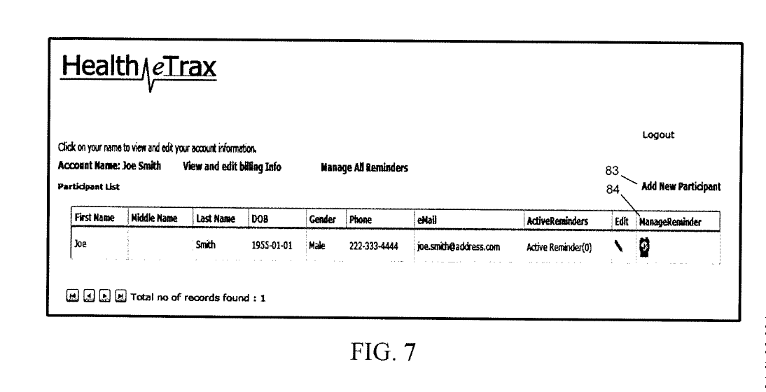

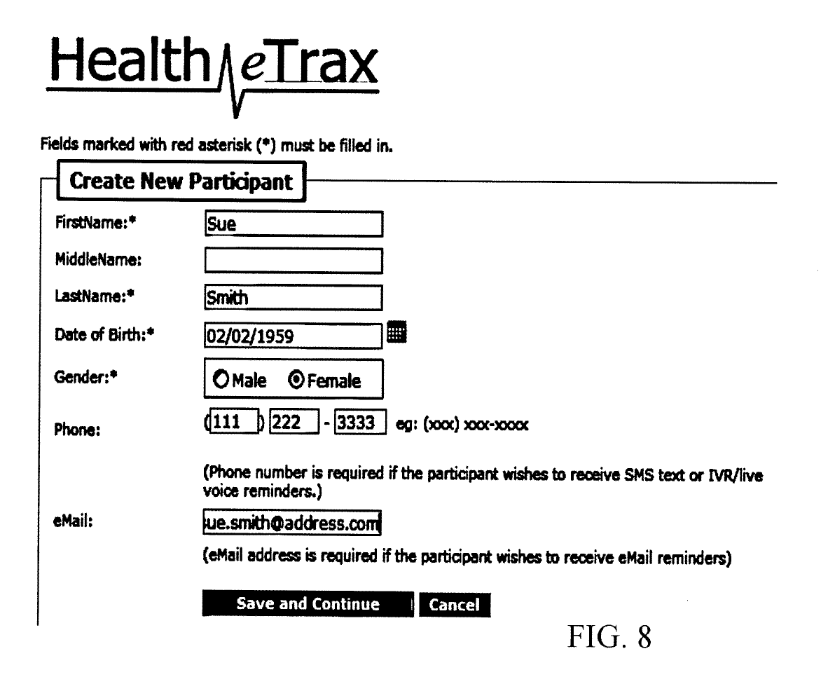

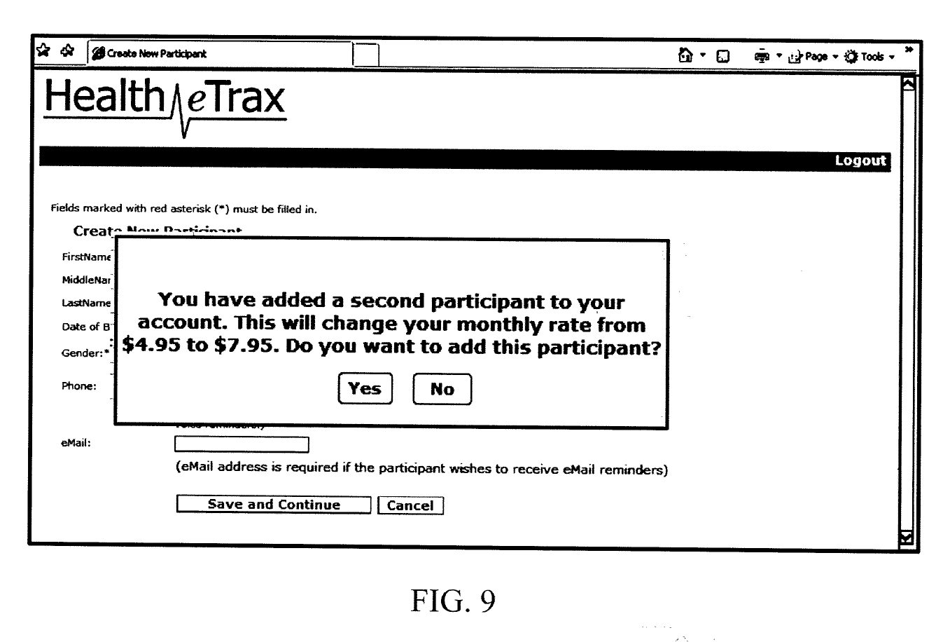

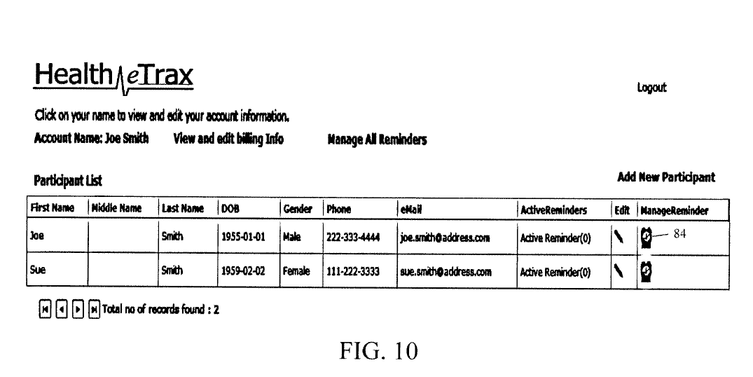

Non-sponsored new users are directed to a billing information screen that requires the new account holder to input information for billing purposes, as depicted in FIG. 6. Billing information is retained by the Data Module 50 and can be made available to an electronic billing system (not shown) for integrated billing. Once billing information is saved the user is presented with the participant list screen depicted in FIG. 7 initially containing only the name of the primary account participant. Clicking on the “add new participant” link 83 presents the user with a new participant information input screen, FIG. 8, where basic new participant information can be entered and saved and new participants added to the account participant list which is depicted in FIG. 10 with the exemplary newly added participant. Where applicable (such as for non-sponsored accounts), the system warns that the addition of additional participants may incur additional fees and request confirmation, as shown in FIG. 9. Participants may then review and manage their own reminders by clicking the “manage reminders” link 84 associated the each participant on the participant list as depicted in FIG. 10. Observe that the primary account participant cannot be deleted from the participant list but that additionally added participants may be deleted.

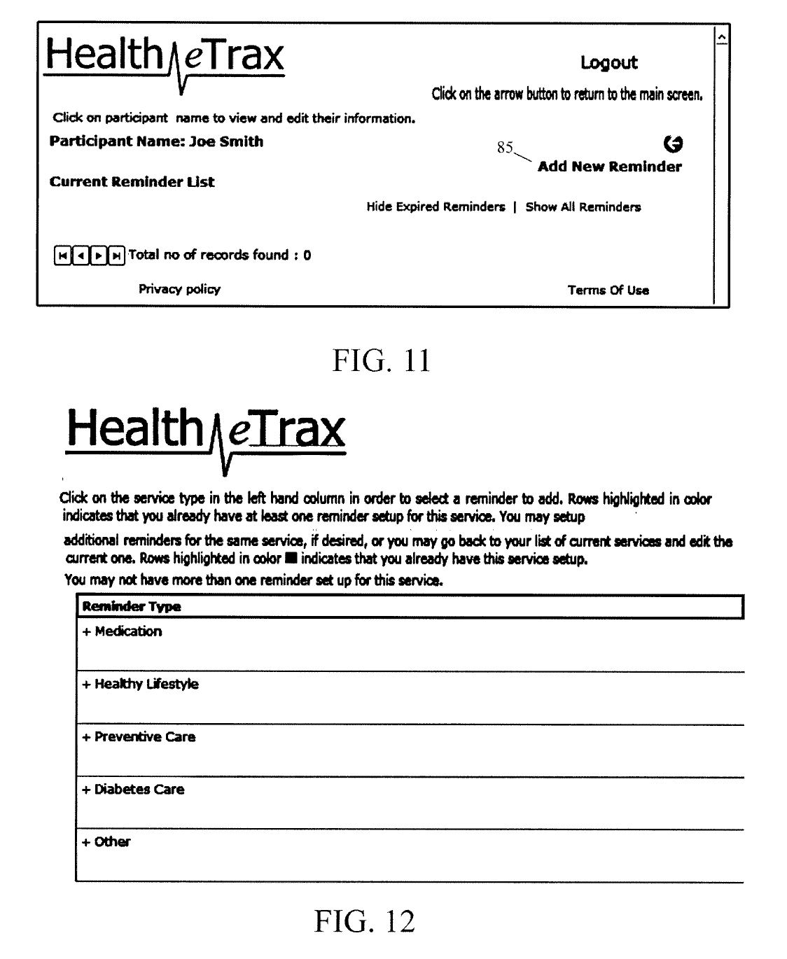

With reference to FIG. 11, an initially empty Current Reminders List is presented to the user who may select the “Add New Reminders” link 85 in order to add reminders. Upon doing so the participant is presented with a list of available reminder categories from which to choose, as depicted in FIG. 12, The exemplary list of available reminder categories includes Medication Reminders, Healthy Lifestyle Reminders, Preventative Care Reminders, Diabetes Care Reminders, Coronary Artery Disease Reminders, Congestive Heart Failure Reminders, COPD Reminders, Kidney Failure Reminders, Sleep Disorder Reminders, Asthma Reminders. Additional reminder types may be added or omitted by the participant sponsor where the participant is sponsored. Certain types of reminder, such as a medication reminder, can be set up numerous times. Others, such as a preventive blood pressure screening, are only permitted once per participant. Wizards (not shown) are available to assist users with setting up multiple reminders commonly associated with or necessary for the care of a previously identified known condition or illness suffered by the patient such as diabetes or lupus.

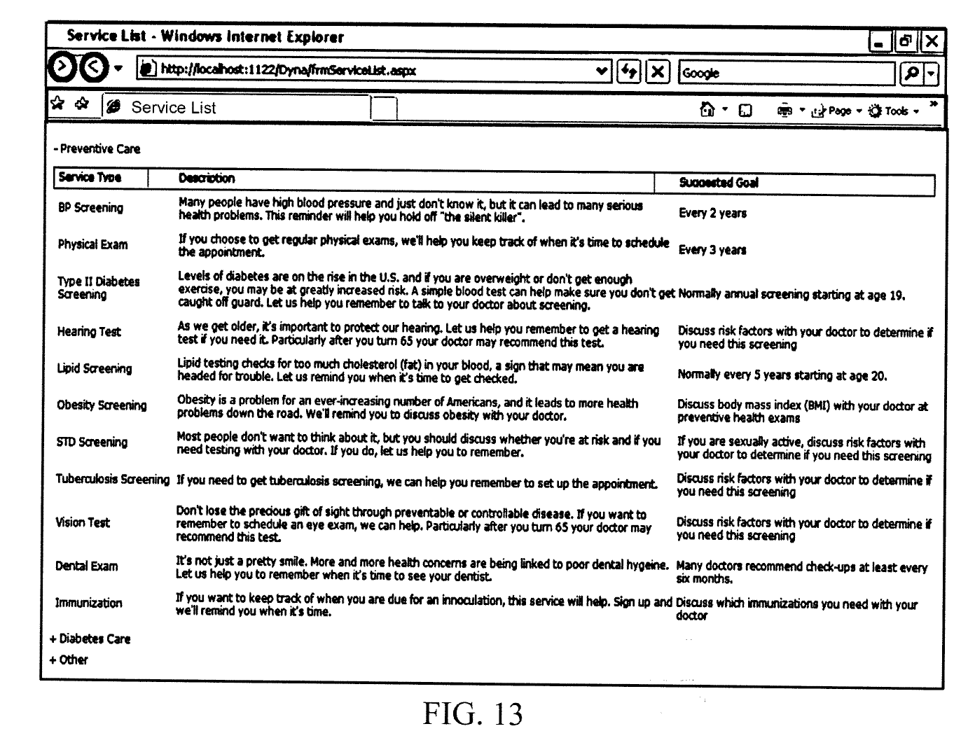

Selecting a reminder type, such as for example Preventative Care, displays a gender and age sensitive list of available reminder service types (FIG. 13) including a short description of the services and its importance. Also provided is an age and gender sensitive suggested goal for frequency of each service. The default frequency goals are those suggested by U.S. Government agencies or other advocacy organization (such as the American Diabetes Association) standards of care, For example, health experts from the U.S. Preventive Services Task Force to the U.S. Department of Health and Human Services have recommended that men over the age of 50 have their blood pressure checked at least every 2 years. Similarly, the American Dental Hygienists' Association recommends that teeth be cleaned and checked every six months. However, both the descriptions of each service and the suggested frequency goals are configurable according to the recommendations and desires of sponsoring organizations to reflect increased or reduced recommended frequency for their sponsored participants. Such changes are stored in the Rules Module 70. Similarly, the list of service types may be expanded or contracted with respect to a participant or participant pool by a sponsoring organization. Clicking on one of the services takes the user to a set up screen for that service.

In an embodiment of the present invention the system interfaces with Electronic Personal Health Records such as those offered by Google and Microsoft, the Electronic Medical Records of participating treating physicians and/or hospitals, and with the electronic data stores of participating insurers, or any other Health Information Exchanges. At the instruction of the participant, the Analysis Module 60 will automatically scan these sources to identify potential conditions and related reminders that may be of interest to the participant and highlight such items within the list of services or in a separate list. The participant may select to setup an identified reminder based on the found information and analysis or to modify the information as necessary to provide the desired reminder.

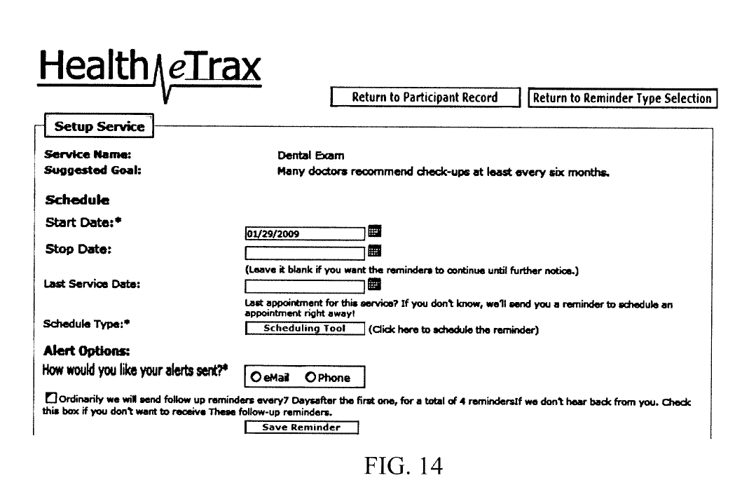

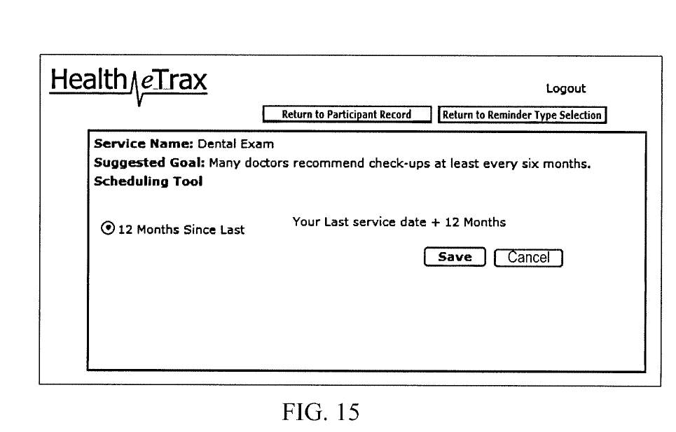

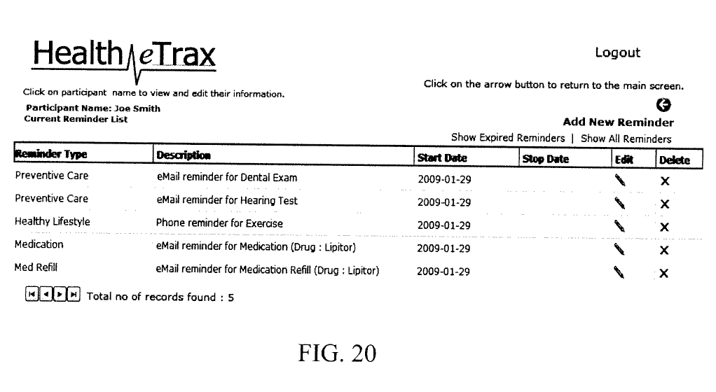

After selecting a service type from the list or having services automatically identified from electronic records a reminder setup screen as in FIG. 14 is offered to configure the service. The type of service (in the exemplary case a dental exam) is listed along with the suggested frequency. The user may then select a start date and (optionally) a stop date for period in which to receive reminders related to this service. The user then enters the date the last time this service was received in order to specify a starting point from which to calculate when reminders are to be sent. If the user does not enter a date or cannot recall the date the system presumes the service has not been received within the recommended guideline and sends a reminder immediately. The user can select the scheduling tool set up the reminder delivery schedule (FIG. 15). Lastly, the user specifies how the reminder alerts should be sent. Automated reminders can be sent, in the depicted exemplary embodiment, by email or SMS text message. Other automated communications may also be incorporated including IM and IVR or live phone Depending on the level of service additional per call charges may apply for certain communications means such as IVR or live phone. If the participant does not wish to receive follow-up reminders after the initial alert reminder until the participant acknowledges completing the service the check box opting out of this element of the service may be selected. A notes field is provided for use at the users discretion. Once saved the reminder is listed on the participant's reminder list as shown in FIG. 20.

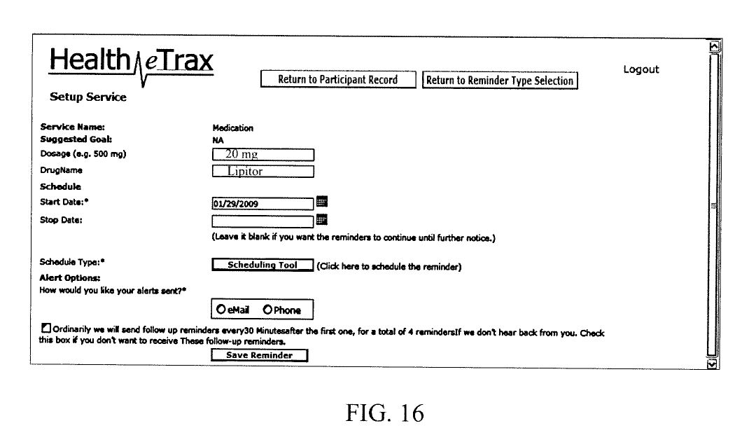

A similar setup screen is presented to the subscriber when setting up a medication reminder, as depicted in the exemplary embodiment of FIG. 16. No service frequency goal is offered as medications are taken as directed by the prescribing physician. Rather, the participant enters the name of the drug (generic or name brand) and the dosage. The participant again specifies a start and end date for the period in which to receive reminders. For maintenance medications that have no anticipated end date, the end date field may again be left blank. Where a medications is to be taken for a particular period, as in for example a round of antibiotics, the end of the reminder period should coincide with the end of the treatment schedule.

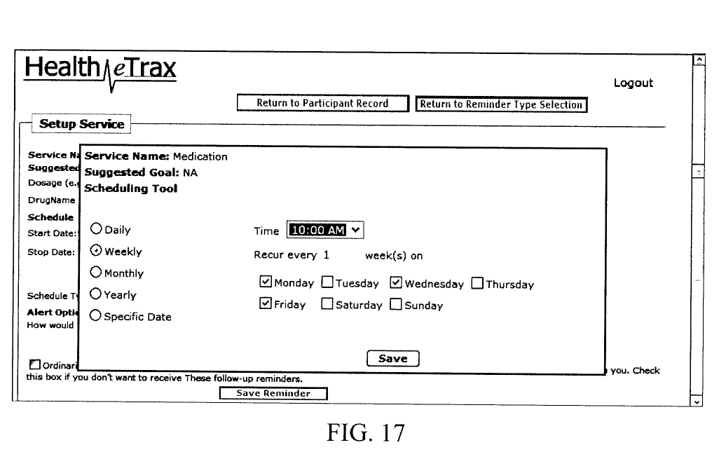

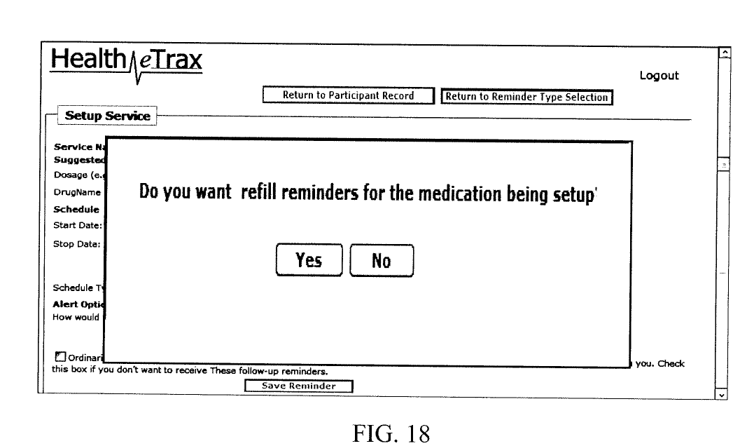

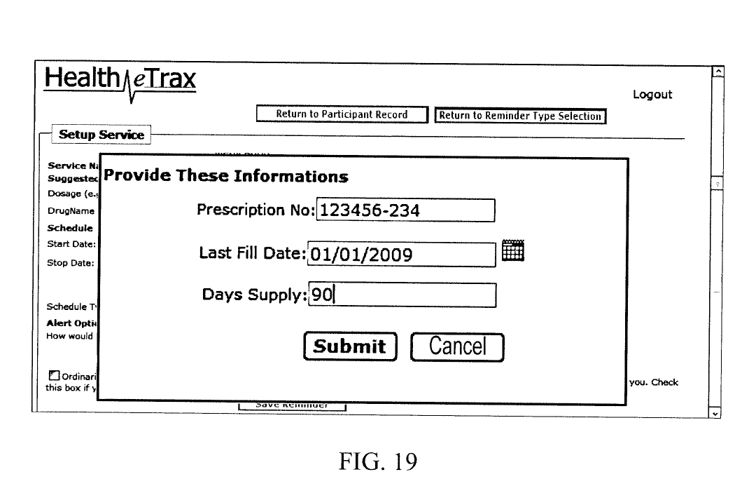

The scheduling tool for the medication reminder (FIG. 17) offers significantly more options, allowing the participant to schedule the time and recurrence on a daily, weekly, monthly or yearly basis as well as to on a specific date. Multiple entries can made where a user must take a certain prescription several times a day. The scheduling tool further provides the participant the option of scheduling a reminder for refill of the prescription (FIG. 18). If such a reminder is desired the participant is requested to enter the prescription number, last fill date and the number of days the prescription is to last (FIG. 19). The system will then remind the participant by the preferred communications method to take the proper medication at the appropriate time and to refill the prescription when necessary. In one embodiment of the present invention the system communicates with the prescription system 91 of participating pharmacies and can transmit a refill request to the pharmacy if directed to do so in response to a reminder to the participant or, in some cases, entirely automatically.

The reminder list is populated, as in FIG. 20, with all of the currently scheduled reminder types for quick reference by the participant and for editing or deleting when modification is desired. A status light icon 109 is provided relative to each reminder indicating the relative time until the next action is due in relation to the particular reminder. For example, for professional services reminders the icon will turn yellow when the participant is within a certain margin time period prior to a next due appointment and subsequently shift to red if the appointment becomes overdue. For self administered services the icon displays yellow or red if the participant is not recording compliance frequently enough or if the scores are outside certain margins relative to the goal. Margins vary with reminder type and are maintained in the Rules Module.

A calendar display of upcoming appointments and reminders (not shown) is also available in which dates are marked indicating when a participant has an upcoming event. The calendar may be displayed in weekly or monthly look ahead format. Selecting a particular date in calendar view displays all reminder activities for that day and, in some embodiments, activities that are in the yellow or red periods as indicated by the status light icon. Alternately a brief summary lists view of activities that are coming up in the next week (or other selected time period) and those that are overdue maybe called up. Similarly a list of current/overdue items (i.e. activities that are in the yellow or red periods as indicated by the status light icon) may be called up and selected to display item details. If desired, participants can manage care solely from this interface, and not receive any emails, text messages, or phone calls for one or all services,

Once the user has set up a reminder, a behind the scenes scheduling sub-module (not shown) of the Reminders Module 40 schedules reminders to be sent at the appropriate date and time. The Communications Module 80 issues the scheduled reminder at the direction of the scheduling sub-module to the participant by the communications method specified for each particular reminder, selecting the appropriate communication protocol and interfacing with the appropriate system. For example, where email is the specified delivery method, the Communications Module 80 would interface with the email communications server 65 server to generate and send the reminder message. Where IVR phone is selected the Communications Module interfaces with the IVR platform to generate the reminder call and contact the user via the wired or wireless telecommunications system 71 and a land based or mobile phone 42, 43.

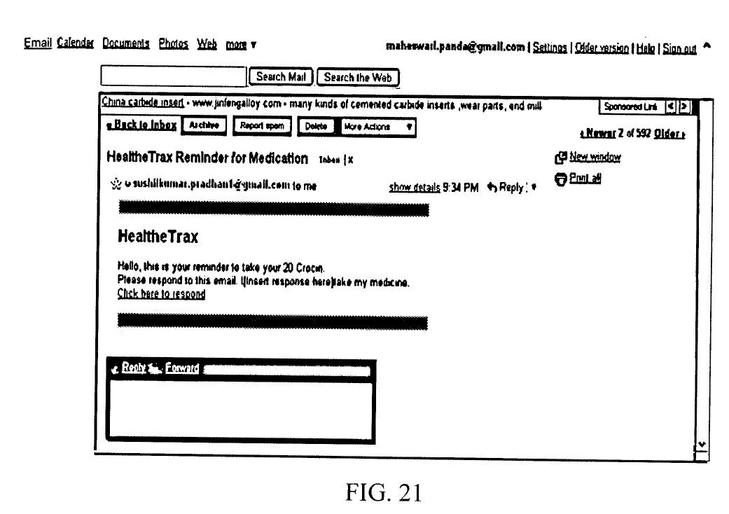

Reminders are sent under one of two paradigms. For self-administered service, such as for example reminders to take one's medication or to exercise, the reminder includes the ability for the user to respond to the reminder to confirm, in the example, that they took the medication. With reminders to exercise the response might be the number of minutes exercised and, in some cases, the maximum heart rate achieved. If using email, the user can either respond directly to the email, as depicted in the email reminder of FIG. 21, or can click on a link in the email to login to the system to record their response. Users concerned about security or particularly sensitive to privacy issues might select the link option. However, it should b observed that for security purposes email responses contain only the data value and an event ID that is not correlated to the participant outside of the system such that the data, if somehow intercepted or collected by others, would not be linkable with a particular participant. With reference to FIG. 20, the email message provides bracketed place holder text 19 such as, in the depicted embodiment “I [Insert response here] take my medicine”, into which the participant can simply insert “did” or “did not”.

Some reminder types include only a single data element response, as discussed above, while others, such as blood sugar self-testing by diabetics, require two data elements such as the blood sugar score and whether the test was performed before or after eating. All responses are passed from the communications module 80 to the data module 50 and recorded by the system. Data points are captured for use and analysis by the system (i.g. Analysis module 40), the participant, and the participant's medical professional's 93 if the user chooses to share the information with those professionals. Follow-up messages are sent periodically if no user response is received if this feature has not been disabled by the participant.

Reminders for professionally administered services such as Hemoglobin A1C tests for diabetics are delivered under a second paradigm. In such cases the reminder message prompts the user to respond with the date and time of their scheduled appointment as well as the name of the doctor or practice group. The Reminder Module 40 then automatically directs the scheduling sub-module to schedule a reminder to be sent the participant in advance of the appointment, usually the day before. The Reminder Module 40 sends confirmation messages after the scheduled appointment time to confirm that the participant kept the appointment. If the appointment was missed the participant is provided with the opportunity to respond with a new appointment time and date and the cycle repeats until the appointment is kept. If the appointment was kept the Reminder Module 40 updates the “last service date” record for that service type with the appointment date and begins tracking again in order to schedule the next reminder for that service type based on the recommended frequency (as specified in the Rules Module 70) so as to know when to send the next reminder.

A Reporting Module 90 is provided to generate and display a variety of reports that participants can use to view their progress for a particular service type over time. For example users quickly see their exercise frequency and their ability to maintain their routine. More advanced reports might correlate the time of day of a workout with the maximum heart rate to help identify when a participant gets the best workout. Other reports might show compliance with a pharmaceutical regimen or blood sugar levels over time. Reports can be printed and shared with health care providers for improved accuracy and care. In an alternate embodiment a Monitoring Module 100 allows a participant to grant a particular health care provider access to certain records to monitor progress or compliance. For example, a prescribing physician 93 could monitor a patient's compliance with the prescription or exercise plan. The physician could further utilize the secure communications abilities of the system to communicate with the patient with respect to the monitoring in order to offer encouragement or direction. The physician can send a message to the patient directing that they exercise more frequently or vigorously. The user would get a message letting them know that they have a message from their doctor and a link to the message. When selected, the user would receive the doctor's message and can reply. Monitoring module 100 may provide access to the healthcare professional through the previously described communications means such as email or may provide a web portal similar to the home web portal 10 which, after verifying the credentials of the healthcare provider, permits the provider to view participant records.

Where the present invention is sponsored by an employer or an insurer, the Monitoring Module may be configured to provide participant compliance information on an individual or aggregate group basis in order to support a reduction in health care insurance premiums for the participant or participant group. All sharing of a user's individual information with an employer, insurer, or healthcare provider will require the user's permission to do so (via a checkblock on the registration screen). Users will be advised of any potential use of their information in de-identified aggregate format as part of the end user agreement,” Individual information will never be shared without permission.

In yet another embodiment of the present invention the Communication Module communicates with the scheduling systems of participating physicians 93 to allow participant to schedule appointments via the system. For example, when a doctor visit is due, the system checks the availability of appointments with the specified doctor and sends a message to the participant suggesting an appointment time and date. The user can accept the appointment or choose an alternate time and date that is available according to the doctor's schedule system, as checked by the communications module. A similar transaction permits the participant to reschedule missed appointments by this method.

Referring back to FIG. 1, a Coaching Module 120 is provided for use by case managers, lifestyle coaches, personal trainers, and similar individuals (all herein referred to as coaches) to allow them to set up and store programs for their clients who are participant-users. The Coaching Module 120 presents an interface specially adapted to allow authorized third-party coaches to enter their programs including educational material, regimens and reminders scheduled reminders to he sent to participant-users. Using the interface, for example, a dietician can set up a schedule of reminders for healthy eating tips, calorie/carb/fat gram counters, etc., on behalf of one or more participant-users. A personal trainer can set up a schedule for exercise along with specific instructions. The Coaches can then assign stored programs to individuals or groups of participant-users, and can customize the program for each individual if desired. Once a program is assigned to a user an invitation to participate is generated and sent to each assigned user. The user may accept the invitation, and upon acceptance may select method(s) of communications by which messages, content and reminders are to be received, and responses sent. The Coach can monitor progress of the client(s) through the coaching portal, modify the assigned programs as desired, and communicate encouragement, pointers, etc. to the user(s) all via each user's personally-preferred communication method.

In addition, a HealtheChallenge module 140 is provided for allowing any user of the system to identify and define a challenge they would like to issue to one or more other users. A challenge may include goal-oriented matters such as physical fitness challenges (total or average miles run over a certain period of time, weight lifted, etc), healthy lifestyle challenges (weight loss, smoking cessation), etc. Again, once a challenge is issued to a user an invitation to participate is generated and sent to each assigned user. The user may accept the invitation, and upon acceptance may select method(s) of communications by which messages, content and reminders are to be received, and responses sent. The issuing and accepting users can monitor progress toward the challenge, and communicate encouragement to each other, all via each user's personally-preferred communication method.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A user administered system for assisting a participant to identify and manage the steps necessary to maintain improve their healthcare and wellbeing, the system comprising
an account module for receiving participant account data over a network, said data including one or more existing user communications paths;
a participants module for receiving participant data over a network:
a reminder module for creating at the direction of the participant reminders to complete acts beneficial to the health and well being of the participant and for scheduling the delivery of said reminders;
a data module for storing received and generated data;
a rules module for specifying the scheduling frequency rules for standard reminders;
an analysis module for applying said rules to said reminders and for analyzing electronic medical data to identify reminder candidates;
a communications module for facilitating communications of said reminders to the participant using any one or more existing user communications paths of the participant's choosing, without any specialized equipment;
a reporting module for generating reports on said participant data.

2. The system of claim 1 further comprising a monitoring module for providing controlled access to participant data to healthcare professional.

3. The system of claim 1 further comprising a coaching module or use by coaches to set up and store programs for users.

4. The system of claim 1 further comprising a challenge module for allowing a user to define a challenge to be issued to other users.
